(19) United States
(12) Patent Application Publication
(10) Pub. No.: US 2024/0294079 A1
(43) Pub. Date: Sep. 5, 2024

(54) VEHICLE CHARGING SYSTEM

(71) Applicant: Kamil Podhola, Liberec (CZ)

(72) Inventor: Kamil Podhola, Liberec (CZ)

(21) Appl. No.: 18/442,504

(22) Filed: Feb. 15, 2024

(30) Foreign Application Priority Data
Jul. 20, 2021 (WO) PCT/IB2021/056558

(51) Int. Cl. B60L 53/24; B60L 53/66; B60L 53/80

(52) U.S. Cl. CPC B60L 53/24; B60L 53/66; B60L 53/80; B60L 2200/28

(57) ABSTRACT

The invention relates to a vehicle charging system for an electric vehicle (VCS) comprising a vehicle providing one or more wired/wireless charging stations to charge/discharge the electric vehicle. The system may provide data transmissions and may be provided in cloud/fog/edge computing systems. The (electric) vehicle may be powered by various propulsion systems. It may provide defined undercarriages, power generators, use regenerative power, swap, provide rechargeable power sources/swappable rechargeable power sources and a thermal management system. The charging stations may provide charging interfaces and both may be provided at about defined constructions, be adjustable, mobile. The VCS may be provided in an electric vehicle charging system comprising coupled electric vehicles and in an onshore/offshore/aerospace static/dynamic charging system comprising a coupled power source to provide power while the vehicle be stationary or in a motion. The VCS may be provided in a modular system. Vehicle charging and swapping methods are proposed.

This application claims the benefit and priority of International Application No. PCT/IB2021/056558, filed on Jul. 20, 2021 Jul. 20, 2021) and is hereby incorporated by reference in its entirety.

### TECHNICAL FIELD

The invention relates to a charging trailer system for an electric truck or locomotive.

### BACKGROUND ART

There is a wide range of electric vehicles, of vehicles able to transport the electric vehicles which are gaining popularity and are becoming more available for a wider range of consumers. The vehicles may comprise a rechargeable power source/swappable rechargeable power source. The electric vehicles may have an improved ecological impact and may be one of sustainable forms of onshore transportation. Many people and companies are attracted to them because they want to decrease their personal impact on the environment through transport.

US 2012/303397 A1 (PROSSER RONALD D [US]) 29 Nov. 2012 (20Dec. 11, 2029) discloses a charging service vehicle networks including battery module-powered EV charging roadside service vehicles.

US 2017/327091 A1 (CAPIZZO PETER D [US]) 16 Nov. 2017 (2017-11-16) discloses an Automatic Service Station Facility (ASSF) for replenishing various motivational energy sources onboard different types of AUV, Drones, and Remotedly Controlled (RC) or robotic vehicles.

US 2021/162874 A1 (LEE YOONHEE [US]) 3 Jun. 2021 (2021-06-03) discloses a charging system for one or more electric vehicles with an energy transport system which can be integrated with any transportation vehicle including an electric propulsion power source.

DE 10 2010 010119 A1 (KERN JUERGEN [DE]) 8 Sep. 2011 (20Nov. 9, 2008) (hereinafter “D8”) discloses a transporter, in particular a truck, an automobile, a railway wagon, a bus, a trailer or the hike, for transporting motor vehicles, comprising a loading surface for receiving the motor vehicles, wherein the transporter further comprises a device for electrically charging the motor vehicles.

EP 2 927 045 A1 (ATOS IT SOLUTIONS AND SERVICES GMBH [AT]) 7 Oct. 2015 (2015-10-07) (hereinafter “D9”) discloses a charger for an electric vehicle on a train wagon comprising a first electric interface for connecting to a busbar of the train wagon, a second electric interface for connecting to the vehicle and a power converter for converting power from the first interface into power for the second interface. In this, the charger is adapted to be moved between train wagons.

DE 10 2019 007810 A1 (DAIMLER AG [DE]) 9 Jul. 2020 (2020-07-09) (hereinafter “D10”) discloses a charging station for a rail vehicle for transporting motor vehicles, comprising a charging unit having a charging connection, designed to charge a traction battery of an electrically operable motor vehicle when the charging station is arranged on a transport device of the rail vehicle, and having a control unit for controlling the charging of the traction battery, wherein the charging station is designed to obtain electrical energy for charging the traction battery via the rail vehicle from an overhead line. The invention also relates to a method for simultaneously transporting and loading motor vehicles on a rail vehicle. A further aspect of the invention relates to a rail vehicle having the above-mentioned charging station.

The documents fail to disclose a charging trailer providing a charging/discharging power for an electric truck or locomotive. The documents further fail to disclose a charging trailer charging method comprising a step of loading electric vehicles on such a charging trailer providing one or more charging stations and provided in a static/dynamic charging system comprising a power source coupled to provide said one or more charging stations with charging/discharging power and a step of charging/discharging the electric vehicles by means of the charging stations while the charging trailer is stationary or in motion. The documents fail to disclose a charging trailer charging method for an electric vessel comprising a step of locating the charging trailer on shore at the electric vessel situated off shore and a step of charging the electric vessel stationary or in motion by the charging trailer.

### DISCLOSURE OF INVENTION

The aforementioned deficiencies are therefore solved by the features of claims 1, 15 and 16. In the dependent claims advantageous developments of the proposed system of the invention are given.

The object of the present invention is to propose a charging trailer system for an electric truck or locomotive (VCS) comprising a charging trailer coupled or couplable with the electric truck or locomotive being at least partially chargeable and/or dischargeable by the charging trailer providing a charging station with a wired charging interface or a charging station with a wireless charging interface or combinations thereof to charge or discharge the electric truck or locomotive.

A further object is to propose the VCS with an electric vehicle loaded on the charging trailer.

A further object is to propose the VCS with the charging trailer coupled or couplable via one or more trailers and/or one or more charging trailers and/or one or more vehicles to the electric truck or locomotive.

A further object is to propose the VCS providing data transmissions.

A further object is to propose the VCS with the charging trailer arranged to carry persons and/or objects.

A further object is to propose the VCS with the charging trailer and/or the electric vehicle providing a power generator.

A further object is to propose the VCS with the charging trailer and/or the electric vehicle providing a rechargeable power source.

A further object is to propose the VCS with the charging trailer providing a thermal management system.

A further object is to propose the VCS with a defined charging station.

A further object is to propose the VCS with an adjustable and/or mobile charging interface. A further object is to propose the VCS further comprising coupled electric vehicles to be charged or discharged.

A further object is to propose the VCS in a static/dynamic charging system comprising a power source.

A further object is to propose the VCS in a modular system.

A further object is to propose a charging trailer charging method for an electric truck or locomotive wherein electric vehicles can be loaded on or located at a charging trailer provided in a static/dynamic charging system and providing charging stations to charge or discharge the electric vehicles while in motion or stationary, the charging trailer providing a charging station with a wired or wireless charging interface or combinations to charge/discharge the electric truck or locomotive.

A further object is to propose a charging trailer charging method for an electric vessel located offshore at an onshore vehicle providing charging power transfer while the offshore vessel can be in motion or stationary.

Other and further objects will be explained hereinafter and will be particularly pointed out in the appended claims.

In a first aspect, the invention discloses a charging trailer system for an electric truck or locomotive.

In a second aspect, the invention discloses a charging trailer charging method for an electric truck or locomotive.

In a third aspect, the invention discloses a charging trailer charging method for an electric vessel.

### BRIEF DESCRIPTION OF DRAWINGS

The invention will now be described by way of example. Only essential elements of the invention are schematically shown and not to scale to facilitate immediate understanding, emphasis being placed upon illustrating the principles of the invention.

FIG. 1 is a schematic side view of a charging trailer system according to the present invention. FIG. 2 is a schematic plan view of another embodiment of the charging trailer system further comprising electric vehicles coupled to be charged/discharged.

FIG. 3 is a schematic side view of another embodiment of the charging trailer system providing a thermal management system and provided in a static/dynamic charging system.

FIG. 4 is a schematic side view of another embodiment of the off-road charging trailer system providing a thermal management system and provided in a static/dynamic charging system with the charging trailer arranged to carry persons.

FIG. 5 is a schematic side view of an another embodiment of a motorway charging trailer system providing a thermal management system and provided in a static/dynamic charging system.

FIG. 6 is a schematic side view of another embodiment of the motorway charging trailer system providing a thermal management system and provided in a static/dynamic charging system.

FIG. 7 is a schematic side view of still another embodiment of the charging trailer system providing a thermal management system.

FIG. 8 is a schematic side view of another embodiment of the motorway passenger charging trailer system providing a thermal management system and provided in an static/dynamic charging system.

FIGS. 9a and 9b are a perspective illustration and a schematic side view of another embodiment of the motorway charging trailer system comprising a charging trailer and a thermal management system.

FIG. 10 is a logic diagram of a charging trailer charging method for an electric truck or locomotive.

FIG. 11 is a logic diagram of a vehicle charging method for an offshore vessel.

FIG. 12 is a schematic perspective illustration of an embodiment of a charging trailer charging method for an electric truck or locomotive.

FIG. 13 is a schematic plan view illustration of an embodiment of a charging trailer charging method for an offshore vessel.

FIG. 14 is a schematic perspective view of another embodiment of the charging trailer system comprising a charging double trailer with a wireless charging module and interface.

FIG. 15 is a schematic side view of another embodiment of the charging trailer system comprising a charging trailer with a wireless charging interface.

FIG. 16 is a schematic side view of another embodiment of the charging trailer system comprising a charging trailer coupled via a trailer with an electric vehicle.

### BEST MODE FOR CARRYING OUT THE INVENTION

The following detailed description shows the best contemplated modes of exemplary embodiments. The description is made for the purpose of illustrating the general principles of the invention and in such a detail that a skilled person in the art can recognise the advantages of the invention and can be able to make and use the invention. However, it will be apparent to one of ordinary skill in the art that shown specific details need not be used to practice the present invention. Well-known apparatuses, systems, processes, materials, etc., have not been shown or described in detail in order not to unnecessarily obscure the present invention. The objects and advantages of this invention may be realized and obtained as pointed out in the appended claims. Advantageous embodiments are the subject of the description, the figures and the dependent claims. Additional advantages may be learned by practice of the invention. The detailed description is not intended to limit the principle of the presented invention, but only to show the possibilities of it. The description and the detailed description are exemplary and explanatory only.

The terms used in the claims and the description shall refer to their synonyms as well.

The terms in the description put into parentheses show a variant, an aspect, a possibility, etc., of an element, a feature, a component, etc., of the invention.

As used in the claims and the description, the term “vehicle” shall refer to manned and unmanned vehicles, shall refer to onshore vehicles, shall refer to above ground and under ground vehicles and overwater and underwater vessels, shall refer to amphibious vehicles, etc., and shall refer to models and toys as well, shall refer to convoys and combinations, wherein elements of the invention can be included in a plurality of coupled/couplable vehicles.

As used in the claims and the description, the term “charging station” shall also refer to charger, untethered/tethered charger, charging unit, charging power interface, charging interface with a charging cable, charger with a charging cable, charging/discharging electrocomponents and circuits including converters; inverters, rectifiers; solar charge controllers, wind charge controllers; emitters, transmitters, receivers, transceivers; microwave energy generators, hybrid chargers, hybrid controllers, controllers, processing units, power electronics, AC/DC current generators, shall refer to chargers arranged to provide (at least partially/temporarily) charging and/or discharging for an electric vehicle, shall refer to an energy source/load coupled with primary/secondary energy transfer interfaces, shall refer to an emitter/transmitter/receiver with primary/secondary antennas, shall refer to a transciever system [the system can use (resonant) parasitic tanks, repeating charging interfaces, repeating charging stations, repeating antennas, etc., to wirelessly transfer charging signal at about the vehicle for charging interfaces providing charging power to electric vehicles], shall refer to a device [which can include a (swappable) rechargeable power source and which can function bidirectionally] being able to provide/store energy, shall refer to basic charging/discharging devices [e.g. including a power source or a load, a power transfer interface and a power cable] and shall refer to complex charging stations [e.g. including input/output sections, power/communication sections, controllers, data storages, user interfaces/controls, sensors, payment terminals, charging/discharging procedure assisting/facilitating, etc., devices and aids/e.g. retractable devices, waterproof covers, manipulation aids, etc./, devices providing indicating, highlighting functions/e.g. color, sound markers/interfaces, etc./] which components can be centralised and provided in a (compact) unit and/or which can be distributed [e.g. at about a vehicle/electric vehicle or in a functional, local, temporal relationship/e.g. some components of the system can be provided in detached systems/, etc.], shall refer to charging devices configured to charge rechargeable batteries and/or capacitors and/or energy storage elements, shall refer to systems using smart power cables, and shall refer to smart chargers, bidirectional chargers, Level 1, 2, 3, 4 chargers, (fast) AC chargers, (fast) DC chargers, proprietary (e.g. Tesla) chargers, inductive, capacitive, magnetodynamic, electromagnetic chargers, combined chargers, etc.

As used in the claims and the description the term “charging station types” shall also refer to a combined charging station providing different charging units [e.g. AC and DC] with respective charging interfaces.

As used in the claims and the description, the term “electric vehicle” shall preferably not exclusively refer to onshore rechargeable vehicles at least partially electrically driven. The term shall refer to manned and unmanned electric vehicles, and shall refer to any type of the electric vehicle (including fully electric and hybrid electric) including an electric propulsion system and/or coupled/couplable with an electric vehicle including an electric propulsion system to directly or indirectly propel the electric vehicle [e.g. to tow the electric vehicle, etc.], shall refer to amphibious electric vehicles, drones, etc., and shall refer to models and toys as well, shall also refer to the electric vehicles arranged to use charging/discharging power for non-propelling reasons [e.g. auxiliary, mobile technology/e.g. cooling systems, etc./], shall refer to convoys and combinations including at least one electric vehicle, shall refer to electric vehicles including or coupled (couplable) with smart chargers, bidirectional chargers, Level 1, 2, 3, 4 chargers, (fast) AC chargers, (fast) DC chargers, proprietary (e.g. Tesla) chargers, wireless inductive, capacitive, magnetodynamic chargers, electromagnetic chargers, combined chargers, etc. The electric vehicle need not provide (to contain or to be coupled with) a (swappable) rechargeable power source [e.g. a high voltage rechargeable battery pack], in such a case the terms “chargeable and/or dischargeable”, “at least partially charging and/or discharging”, etc., shall refer to a (bidirectional) power transfer which can eventually charge/discharge the (swappable) rechargeable power source provided by the vehicle [e.g. a hybrid electric truck can be provided with a high voltage battery included in a trailer].

The “charging stations” and the “electric vehicles” can be compatible so that the electric vehicles can be at least partially chargeable and/or dischargeable by the charging stations. The compatible wired systems can use compatible wired power transfer interfaces [e.g. AC sockets/JSAE 1772, Mennekes Socket, Le-Grand Socket, etc./, DC sockets/CHADeMO, ChaoJi, GB/T, Tesla Supercharger, ChargePoint, etc./, CCS sockets; AC/DC power connectors; systems conform with international and national standards/e.g. ISO (International Organisation for Standardization), IEC (Interantional Electrotechnical Comission)//e.g. IP/Ingress Protection/rating//, American UL (Underwriters Laboratories), Chinese GB (Guobiao), Regolamento Internazionale delle Carrozze (RIC), shore connection standards, etc./; car power adapters; trailer power connectors; head-end power (HEP) or electric train supply (ETS) systems; standard domestic sockets for electric bikes, EnergyBus connectors; XLR (External Line Return), RCA (Radio Corporation of America), Anderson connectors, etc.], and similarly for compatible wireless power transfer interfaces [e.g. inductive/strongly coupled magnetic resonant pads, double D magnetic polarized pads, etc./, capacitive/primary and secondary capacitive plates, etc./, magnetodynamic/transmission and receiving magnetodynamic interfaces/, electromagnetic interfaces, etc.].

The charging systems provided in the proposed charging trailer system for an electric vehicle, in the electric vehicle charging system, in the static/dynamic charging system and/or in the vehicle charging method for an electric vehicle can be static, dynamic [e.g. dynamic wired, dynamic wireless] and can be combined [e.g. AC/DC, wired/wireless, inductive/capacitive, inductive/electromagnetic, static/dynamic, etc.] and can use combined charging interfaces, combined circuit topologies, combined charging units, etc.

As used in the claims and the description, the term “person” shall also refer to passengers, and the like, and shall also refer to animals.

As used in the claims and the description, the term “object” shall also refer to goods, merchandise, products, ware, and the like.

As used in the claims and the description, the term “power generator” shall preferably not exclusively refer to electric energy generating systems using an electrical generator coupled with an engine [e.g. an internal combustion engine, a jet engine, etc. using preferably not exclusively hydrogen gas, (organic) hydrogen liquid, compressed natural gases, liquefied natural gases, biofuels, low sulphur fuel oils, emulsified fuels, methanol, mixtures, hydrocarbon fuels/, a gas generator, a turbine, etc. | and shall also refer to alternators, dynamos, etc., shall also refer to electric devices providing regenerative braking and shall also refer to mobile units, compact units, enclosed units, portable units, skid mounted units.

As used in the claims and the description, the term “bidirectional flow” shall preferably not exclusively refer to bidirectional power and/or data flow, shall refer to sensor and actuator systems, shall refer to power and data interfaces, circuits, controllers, etc., shall refer to power to grid, vehicle to grid, electric vehicle to grid, etc., applications and bidirectional wired/wireless communication systems.

As used in the claims and the description, the term “rechargeable power source”, “first swappable rechargeable power source”, “second swappable rechargeable power source” shall preferably not exclusively refer to power sources including rechargeable batteries [e.g. strings, packs, modules, cells], capacitors [e.g. strings, packs, modules, cells], hybrid sources, energy storage elements.

As used in the description, the term “rechargeable battery” shall preferably not exclusively refer to lithium-ion, lithium-ion polymer, lithium-air, lithium-sulphur, lithium-metal, lithium iron phosphate, nickel-metal hydride, nickel-iron, nickel-cadmium, lead-acid, valve regulated lead-acid, absorbed glass mat, gel [e.g. for high pressure, high temperature implementations], solid state, organic radical batteries. Rechargeable batteries may include fuel cells, piezoelectric elements, nano-materials, springs. A variety of arrangements of multiple rechargeable batteries may be used. Rechargeable batteries may be trickle, float charged, charged at fast, slow rates, etc.

As used in the description, the term “capacitor” shall preferably not exclusively refer to supercapacitors (electric double layer capacitors), ultracapacitors, double-layer capacitors [e.g. with activated carbons, carbon aerogels, carbon nanotubes, boron nitride nanotubes, nanoporous carbon, graphene, carbid-derived carbon], pseudocapacitors [e.g. with polymers, metall oxides], hybrid capacitors [e.g. with asymmetric electrodes, lithium-ion capacitors, with composite electrodes], electrolytic capacitors [e.g. aluminium electrolytic capacitors], ceramic capacitors, mica capacitors, film capacitors, chip shape, lead shape capacitors, multilevel circuit board processed capacitors; hermetically sealed tantalum non-solid, tantalum solid capacitors, etc.

As used in the claims and the description, the terms “first swappable rechargeable power source”, “second swappable rechargeable power source” shall preferably not exclusively refer to swappable power sources wherein said first swappable rechargeable power source and said second swappable rechargeable power sources are configured to be swapped at least for each other.

As used in the claims and the description, the term “thermal management system” shall refer to active and/or passive systems. The term shall refer to any possible technology [e.g. passive regulators, active regulators, management systems reporting the state of the source, protecting and thermally managing the source, etc.] and topology [e.g. centralized systems, distributed, modular, cloud-based management, etc.]. The source management system can ensure cell/module/pack balancing by various methods [e.g. wasting energy to a load, shuffling (balancing) energy between cells/modules/packs, reducing charging/discharging current, etc.]. Source protection can include various parameters (e.g. over-/unercurrent, over-/undervoltage, over-/undertemperature, overpressure, ground fault or leakage current detection. Protection can include external/internal switches (switching arrays) [e.g. relays, solid state devices, etc.]. The source management system can request the load [e.g. the offshore vessel] to optimalize [e.g. reduce, or cut off] power transfer parameters. Protection can include active or passive thermal management systems such as air tempering systems [e.g. using fins, fans, air heaters, etc.], liquid tempering systems (e.g. using cooling circuits which can include compressors, condensers, fans, thermostatic expansion valves, heat exchangers, dryers/separators. The systems can include or be coupled to various subsystems [e.g. the water vessel's at least partially electrically driven, etc.] such as power train cooling subsystems, refrigeration subsystems, battery cooling subsystems, heating, ventilation and cooling (HVAC) subsystems. Thermal management systems of the marine rechargeable power source may further include various conduits, valves, pipes, cooling pads, cooling loops, circulation pumps, reservoirs, etc. The source management system can provide monitoring and controlling various source parameters [e.g. cell/module/pack voltage(s), State of Charge (SoC), State of Health (SoH), State of Power (SoP), State of Safety (SoS). Maximum charge/discharge current. Energy delivered since last charge, Internal impedance of a cell, Charge delivered/stored, Total delivered energy. Total number of cycles. Temperature monitoring, etc. The source management system can provide internal communication and external communication [e.g. serial/parallel communication, CAN bus communication, wired/wireless networks communication, and combinations]. Communication can use various wired/wireless communication interfaces, lines, techniques and protocols. The source (battery) management system can directly control DC charging of the rechargeable source. During AC charging, the charge control can be partly taken by an on-board charger responsible for converting AC current to DC.

As used in the claims and the description, the term “tempering systems using phase change materials” shall refer to systems using a pure phase change material (PCM) substance and to systems using methods for increasing the thermal conductivity [e.g. inserted fins, heat pipes; added fillers, foams, particles, nanostructures; metal/semimetal/nonmetal materials; carbon, graphite, graphene, composites, etc.], and to systems using dispersed/decentralised/microcapsule packaging, PCM heat sinks, etc.

As used in the claims and the description, the term “tempering systems using heat pipes” shall also refer to systems using heat sinks, coldplates, heat spreaders, vapor chambers, condensers, evaporators, etc., shall refer to compound cooling, natural convection cooling, and shall refer to systems using thermal conductance materials in any shape and form [e.g. tubes, foams, fibres, etc.] to transport, spread, dissipate, etc., heat/cold, and shall refer to heat switches, as well.

As used in the claims and the description, the term “inductive” shall also refer to resonant inductive, strongly coupled magnetic resonant, etc., and the term “capacitive” shall also refer to resonant capacitive, etc.

As used in the claims and the description, the term “magnetodynamic” shall preferably not exclusively refer to magneto-mechanical systems using translational and/or rotational motion of a magnetic element or arrays of magnetic elements to wirelessly transfer power. The systems can include inductive loops on one side (e.g. a primary side) and inductive loops, piezoelectric transducers, electrostatic transducers on another side (e.g. a secondary side). Magnetic elements can be included on primary/secondary sides.

As used in the claims and the description, the term “electromagnetic” as in “electromagnetic charging station” shall preferably refer to a charging station with a charging interface in a wireless electromagnetic energy transfer system using circular magnetic fluxes generating electric current. The system can provide condenser action.

As used in the claims and the description, the term “electric bicycle” shall refer to electric scooter as well.

As used in the claims and the description, the term “locate” and derivatives as in “locating electric vehicles” shall refer to the vehicles which can be stationary and/or in a (relative) motion when located at the vehicle.

As used in the claims and the description, “A/B” shall refer to A and/or B.

As used in the claims and the description, the singular forms are intended to include the plural forms as well.

The term “to couple” and derivatives shall refer to a direct or indirect connection via another device and/or connection, such a connection can be mechanical, hydraulical, electrical, electronical, electromagnetical, pneumatical, communication, functional, etc., the term shall also refer to attach, detach, detachably attach, mount, connect, fix, join, support, link, bear, fasten, secure, tie, tether, chain, screw, weld, bond, solder, etc.

The terms “to comprise”, “to include”, “to contain”, “to provide” and derivatives specify the presence of an element, but do not preclude the presence or addition of one or more other elements or groups and combinations thereof.

The term “consisting of” characterises a Markush group which is by nature closed. Single members of the group are alternatively useable for the purpose of the invention. Therefore, a singular if used in the Markush group would indicate only one member of the group to be used. For that reason are the countable members listed in the plural. That means together with qualifying language after the group “or combinations thereof” that only one member of the Markush group can be chosen or any combination of the listed members in any numbers. In other words, although elements in the Markush groups may be described in the plural, the singular is contemplated as well. Furthermore, the phrase “at least one” preceding the Markush groups is to be interpreted that the group does not exclude one or more additional elements preceded by the phrase.

The invention will be described in reference to the accompanying drawings.

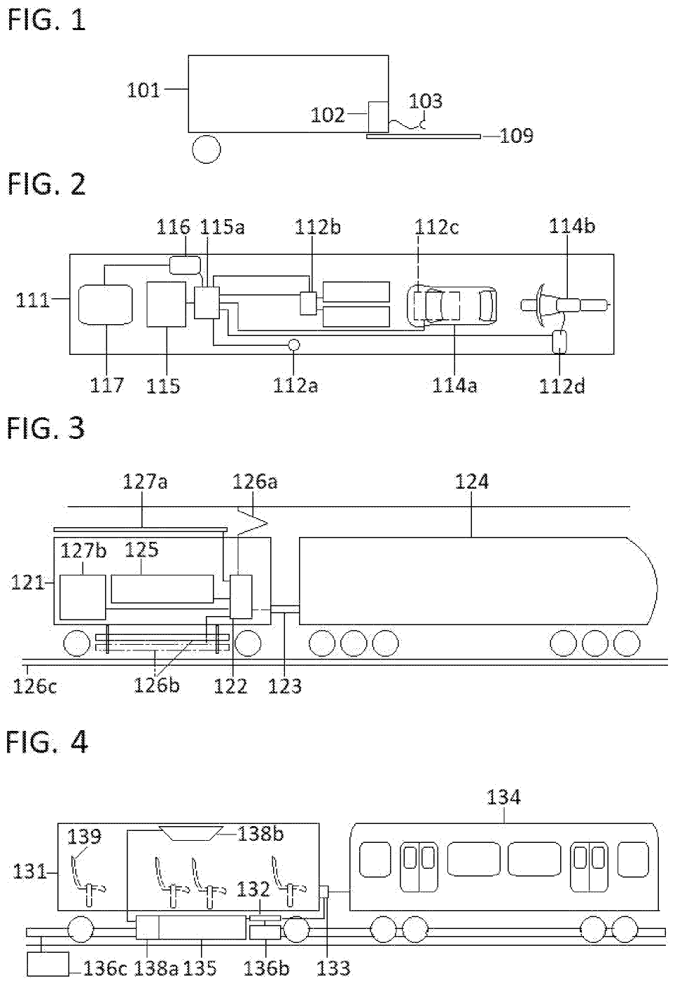

FIG. 1 is a schematic side view of a charging trailer system comprising a charging trailer (101) providing a charging station (102) with a wired charging interface (103) to charge/discharge an electric truck or locomotive (not shown) configured to be at least partially chargeable and/or dischargeable and which can be connectable e.g. by means of a trailer connecting rod (109), a fifth-wheel coupling, etc.

FIG. 2 is a schematic plan view of a charging trailer system comprising a charging trailer (111) providing a wired charging station (112a) [e.g. a fast charging station], a wireless charging station (112b) [e.g. a capacitive charging station], another wireless charging station (112c) [e.g. an inductive charging station] and another wired charging station (112d) [e.g. an AC or DC charging station].

Electric vehicles (114a) [which can be an electric car] and (114b) [which can be an electric motorcycle] can include rechargeable power sources, second swappable rechargeable power sources, source management systems which can include thermal management systems, onboard chargers [bidirectional chargers, smart chargers, etc.], communication units, controllers, protection circuits, compensation circuits, power transfer and communication interfaces, etc., the systems and components can be compatible with the respective charging stations. The electric vehicles (114a, 114b) can be at least partially charged or discharged while the charging trailer (111) can be stationary and/or in motion.

The charging trailer (111) can provide a swappable rechargeable power source (115) [which can include a bank of rechargeable batteries, a capacitor bank, an energy storage element] which can be coupled with a source management system (115a) which can be coupled with a motor generator (116) [which can receive electrical power and provide output torque and which can convert mechanical power into electrical power and which can provide regenerative braking, etc.] which can be coupled with a drive system (117) [which can be an internal combustion engine, an electric motor, etc.]. The system can provide data transmissions in relation with charging/discharging. The source management system (115a) can include and/or be coupled with wired/wireless communication interfaces, communication lines, local/distant networks and use various communication wired/wireless techniques including techniques communicating through charging interfaces [e.g. using communication lines, power lines, etc.].

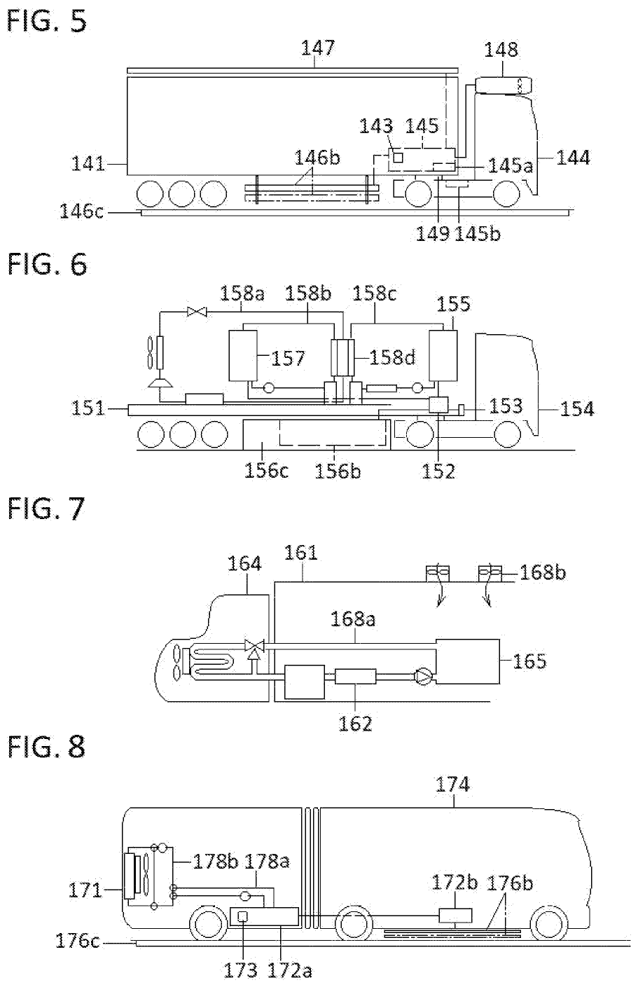

FIG. 3 is a schematic side view of another embodiment of the charging trailer system comprising a charging trailer (121) [which can be a (swappable) rechargeable electric tender which can include traction wheels, a traction bus and a traction system/which can also provide motoring and regenerative (dynamic) braking modes, etc., or which can be a (railway) wagon arranged to carry persons and/or objects] providing a rechargeable power source (125) [which can include a dedicated battery pack, an ultracapacitor, a flywheel, a high voltage power train battery pack, or combinations, which can be coupled with a source management system, a 20) thermal management system, electrocomponents/e.g. converters, processors, controllers, sensors, etc./and which can be effectively cooled similarly shown in FIG. 6] which can be coupled to a power source [e.g. by a pantograph charging interface (126a)] and by a wireless level adjustable charging interface (126b) which can be coupled with a power source (126c) [which can compatible primary wireless power transfer interface of a static/dynamic charging station]. The charging trailer (121) can provide a power generator (127a) [which can be a solar panel which can be provided with a thermal management system/e.g. can be effectively cooled down while in a motion/] and a power generator (127b) [which can be a (modularly configured) hydrogen power unit/which can include a hydrogen gas tank/providing fuel cells and which can be provided with a thermal management similarly as shown in FIG. 6]. The charging trailer (121) can comprise a charging station (122) and a coupling construction (123) [which can be a (railway) coupling operating in a consist] for an electric locomotive (124) [which can be a railway engine, a tramway/which can include a rechargeable power source, a source management system, a (hybrid) electric power train, which can provide regenerative braking, etc.]. The electric trailer (121) can be arranged to use at least partially regenerative power from the electric locomotive (124) to recharge the rechargeable power source (125). The charging trailer (121) can be provided as an autonomous drone.

FIG. 4 is a schematic side view of another embodiment of the charging trailer system comprising a charging trailer (131) [which can be a railway passenger wagon] providing a rechargeable power source (135). The charging trailer (131) can comprise a wired/wireless charging station (132) providing a wired charging interface (133) and a wireless charging interface (136b) which can be couplable with a power source (136c) [e.g. a static/dynamic wireless charging station] which can provide power for a coupled electric locomotive (134) to be charged/discharged while stationary and/or in motion. The charging trailer (131) can provide a thermal management system (138a) which can be a liquid tempering system with a shared heat exhanger as shown in FIG. 6 and which can cool the rechargeable power source (135) can be coupled with a heating, ventilation, air conditioning (HVAC) system (138b) of the wagon (131) which can be arranged to carry persons [e.g. can provide seats (139)].

FIG. 5 is a schematic side view of another embodiment of the charging trailer system comprising a charging trailer (141) [which can be a truck trailer] providing a rechargeable power source (145) [which can be a swappable all-in-one charging module and include a dedicated battery pack and/or a high voltage power train battery pack, a battery management system, power electrocomponents/e.g. converters, processors, controllers, sensors, etc./, communication electronics module, etc.] which can provide a charging station with a wired charging interface (143) and a wireless (level adjustable) power transfer interface (146b) which can be coupled with a power source (146c) [which can be a wireless power transfer interface of a static/dynamic charging station]. The charging trailer (141) can provide a power generator (147) [which can be a solar panel] and a thermal management system (148) [which can be a liquid tempering module containing system electronics, a radiator, a fan, a reservoir, a pump, a heater to ensure optimal temperature, a valve, etc.] and a coupling adjustable construction (149) [which can be a fifth wheel coupling] to an electric truck (144) [which can be a (hybrid) electric truck which can include a rechargeable power source, a source management system, a (hybrid) electric power train, which can provide regenerative braking, etc.] which can be wiredly or wirelessly coupled with a rechargeable power source (145) [e.g. to provide power to the electric vehicle's power train, the electric vehicle's rechargeable power source, etc.]. The charging trailer (141) can be arranged to provide at least partially regenerative power [e.g. to use power from the electric truck (144) to recharge the (swappable) rechargeable power source (145)].

The charging trailer (141) can provide a dedicated, adjustable, mobile, controllable construction [e.g. a mechanic, hydraulic, electromagnetic, robotic arm, a robot, a drone, etc., can be used or another construction can be provided (not shown)] which can assist in swapping of a first swappable rechargeable power source (145a) provided by the charging trailer (141) for a second swappable rechargeable power source (145b) provided by the electric truck (144).

The coupled electric truck (144) can be at least partially charged/discharged while the charging trailer (141) can be stationary and/or in a motion [e.g. on a road, at a parking place, at a cargo terminal, etc.]. The first and second swappable rechargeable power sources (145a, 145b) can be swapped while the charging trailer (141) can be stationary and/or in a motion.

FIG. 6 is a schematic side view of another embodiment of the charging trailer system comprising a charging trailer (151) providing a rechargeable power source (155) [which can be provided with a (modularly configured) thermal management system/e.g. air, liquid tempering systems, etc./] and a power generator (157) [which can be a (modularly configured) hydrogen power unit/which can include a hydrogen gas tank/providing fuel cells]. The charging trailer (151) can provide a thermal management system which can comprise three loops [e.g. the first loop (158a) which can include a dryer/separator, a compressor, a condenser, a thermostatic expansion valve; a second loop (158b) which can provide a cooling system for the hydrogen fuel cell system (157) and which can include a reservoir and a pump; a third loop (158c) which can provide a tempering system for the rechargeable power source (155) and which can include a reservoir, a heater, a pump; all the three loops (or more) (158a, 158b, 158c) can use the same heat exchanger (158d). The charging trailer (151) can provide a combined wired/wireless charging station (152) providing a wired charging interface (153) and a wireless charging interface (156b) [which can be (rotatably) adjustable] which can be couplable with a power source (156c) [e.g. a static/dynamic wireless charging station] which can provide power for a coupled electric truck (154) [which can be an electric truck which can contain a rechargeable power source]. The charging station (152), the charging interface (153), eventually charging cables (not shown) can be similarly provided with cooling loops (not shown).

FIG. 7 is a schematic side view of another embodiment of the charging trailer system comprising a charging trailer (161) providing a rechargeable power source (165) and a charging station (162). The charging trailer (161) can provide a thermal management system which can comprise at least one loop (168a) [which can provide a cooling system for the rechargeable power source (165) and for the system electronics (162)/which can preferably use a cold plate/and which can include a reservoir, a pump, a radiator with a fan and a heater, a thermostat valve]. The thermal management system can further include an air tempering system (168b) [which can include fan/heater modules with system electronics]. The system can charge/discharge an electric truck or locomotive (164).

FIG. 8 is a schematic side view of another embodiment of the charging trailer system comprising a charging trailer (171) [which can be a bus trailer] arranged to carry persons and providing a wired charging module (172a) providing a charging circuitry a rechargeable power source and a charging station with a wired charging interface (173), and a wireless charging module (172b) providing a wireless charging interface (176b) [which can be level adjustable/e.g. can include sensing circuits, actuators, position and charging controllers, etc./(resonant) inductive, (resonant) capacitive, electrodynamic, electromagnetic, etc.] which can be coupled with a power source (176c) [which can be a wireless power transfer interface of an onshore/offshore static/dynamic charging station]. The charging trailer (171) can provide a thermal management system which can comprise at least one loop (178a) [which can comprise a pump] which can be coupled via flow control valves with heating, ventilation and cooling (HVAC) subsystem (178b) of the charging trailer (171). The thermal management system can further include an air tempering system (168b) [which can include fan/heater modules with system electronics]. The system can charge/discharge an electric truck (174) [which can be an electric coach].

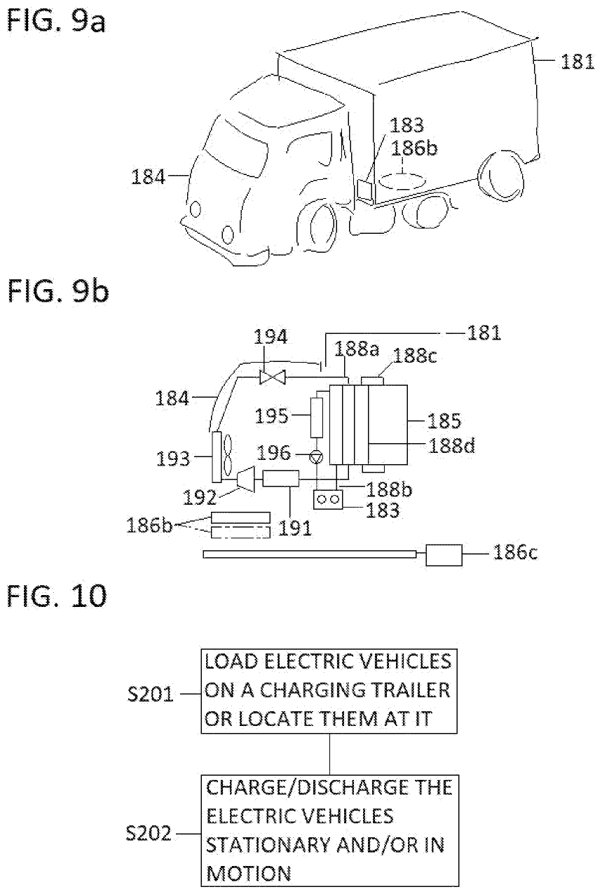

FIGS. 9a and 9b are a perspective illustration and a schematic side view of another embodiment of the motorway charging trailer system comprising a charging trailer (181) providing a rechargeable power source (185). The charging trailer (181) can provide a thermal management system which can comprise three loops [e.g. the first loop (188a) which can include a dryer/separator (191), a compressor (192), a condenser (193), a thermostatic expansion valve (194); a second loop (188b) which can provide a cooling system for the wired charging station and charging interface (183) and which can include a reservoir (195) and a pump (196); a third loop (188c) which can provide a tempering system for the rechargeable power source (185) [e.g. in a direct contact or by means of a cold plate which can also cool power electronics or which can include a reservois, a heater, a pump (not shown)]; all the three loops (or more) (188a, 188b, 188c) can use the same heat exchanger (188d). The charging trailer (181) can provide a combined wired/wireless charging station (not shown) providing the wired charging interface (183) and the wireless charging interface (186b) [which can be height adjustable] which can be couplable with a power source (186c) [e.g. a static/dynamic wireless charging station] which can provide power for the rechargeable power source (185) and for a coupled electric truck (184). Charging cables can be similarly provided with cooling loops (not shown).

FIG. 10 is a logic diagram of a charging trailer charging method for an electric truck or locomotive comprising steps of loading one or more electric vehicles on a charging trailer and/or locating one or more electric vehicles at the charging trailer providing one or more charging stations and provided in a static/dynamic power transfer system comprising a power source coupled to provide said one or more charging stations with charging/discharging power (S201);

at least partially charging and/or discharging one or more electric vehicles by at least one of the charging stations when onboard and/or when located at the charging trailer while stationary or in motion (S202). The charging trailer comprising at least one charging station with a wired charging interface or with a wireless charging interface or combinations thereof to charge/discharge an electric truck or locomotive.

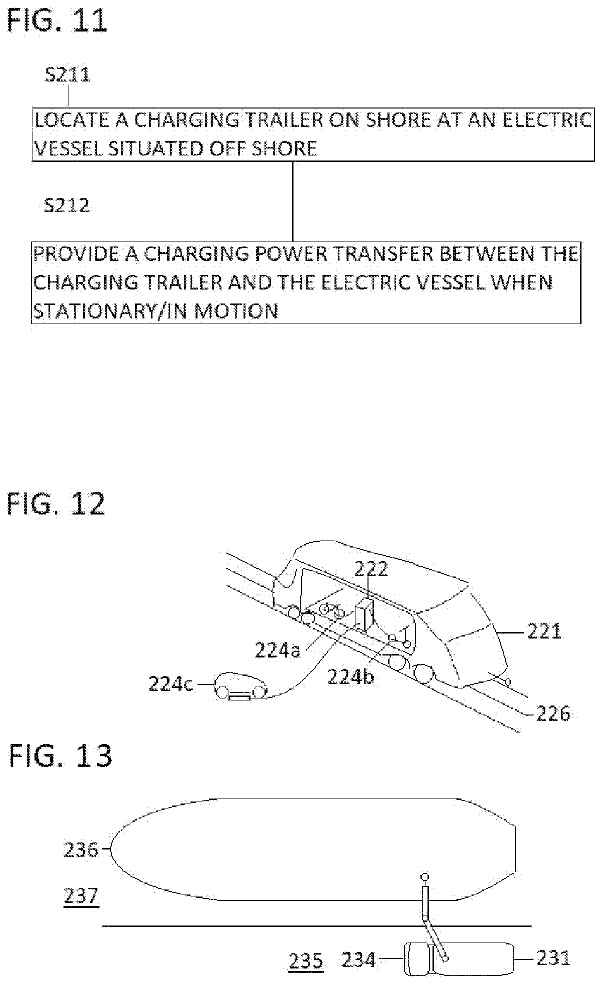

FIG. 11 is a logic diagram of a charging trailer charging method for an electric vessel comprising steps of locating a charging trailer providing charging power transfer on shore at an electric vessel situated off shore and being chargeable by the charging trailer situated on shore (S211);
providing a charging power transfer between the charging trailer and the electric vessel while the electric vessel is stationary and/or in motion (S212). The charging trailer comprising at least one charging station with a wired charging interface or with a wireless charging interface or combinations thereof to charge/discharge an electric truck or locomotive.

FIG. 12 is a schematic perspective illustration of an embodiment of a charging trailer charging method for an electric locomotive comprising a step of loading electric vehicles (224a, 224b) on a charging trailer (221) and locating an electric vehicle (224c) at the charging trailer (221) providing a charging station (222) and provided in a static/dynamic charging system comprising a power source [which can be a third rail (226), a static/dynamic wireless power transfer interface, etc.] coupled to provide the charging station (222) with charging discharging power to at least partially charge or discharge the electric vehicles (224a, 224b, 224c) when onboard or located at the trailer (221) while the charging trailer (221) can be stationary eventually in motion. The charging trailer (221) comprising at least one charging station [which can be the same charging station (222) or a different charging station] with a wired charging interface or with a wireless charging interface or combinations thereof to charge/discharge the electric locomotive (not shown).

FIG. 13 is a schematic plan view illustration of an embodiment of a charging trailer charging method for an electric vessel comprising steps of locating a charging trailer (231) providing charging power transfer on shore (235) at an electric vessel (236) situated off shore (237) and being chargeable by the charging trailer (231) and providing a charging power transfer between the charging trailer (231) and the electric vessel (236) while stationary and/or in motion. The charging trailer (231) comprising at least one charging station with a wired charging interface or with a wireless charging interface or combinations thereof to charge/discharge an electric truck or locomotive (234).

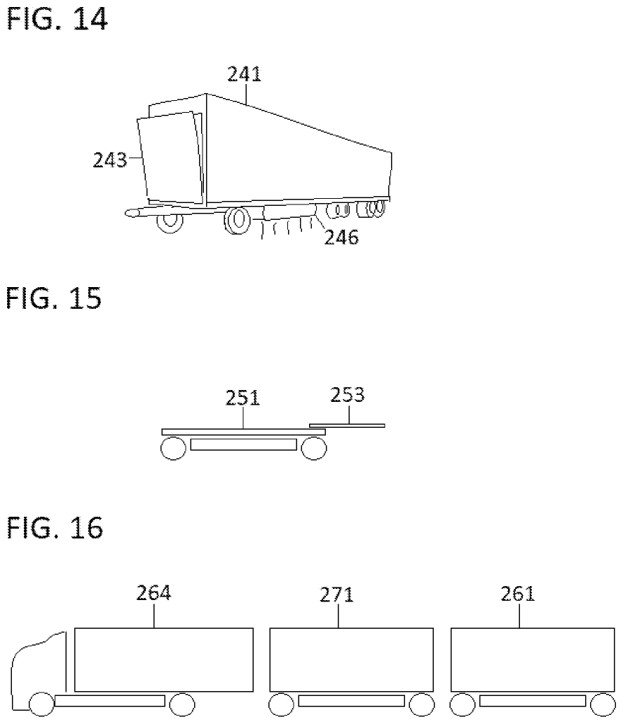

FIG. 14 is a schematic perspective view of another embodiment of the charging trailer system comprising a charging trailer (241) [e.g. a double truck trailer] providing a wired charging interface with power electronics (not shown) [e.g. for coupling with another double/via a dolly/which can be coupled via another wired (or wireless interface) with an electric (or hybrid) truck tractor] and a wireless charging interface module (246) [which can include an inductive, capacitive, electromagnetic and/or magnetodynamic interface, power electronics, communication interfaces, a thermal management system, etc.] which can be couplable with a primary static/dynamic charging station (not shown) [e.g. an inductive, capacitive, electromagnetic, magnetodynamic charging station, respectively] and a charging station with an adjustable wireless charging interface (243) [which can be for example an adjustable (resonant) capacitive, inductive or electromagnetic interface] to charge/discharge an electric truck (not shown).

FIG. 15 is a schematic side view of another embodiment of the charging trailer system comprising a charging trailer (251) with an adjustable wireless charging interface (253).

FIG. 16 is a schematic side view of another embodiment of the charging trailer system comprising a charging trailer (261) coupled via a trailer (271) with an electric truck (or locomotive) (264).

### Common Features of FIGS. 1 to 16

The charging trailer can also charge/discharge by means of included/coupled charging stations the electric vehicles when located [e.g. on a platform, on a pier, etc.] at the charging trailer which can e.g. perform a function of a mobile charging station for the electric vehicles when on shore, on the platform, etc., and/or can be coupled with an onshore [e.g. a (railway) station, a train yard, a dock, etc.] (preinstalled, compatible) charging system, etc. The electric vehicles located at the charging trailer can be stationary [e.g. the electric vehicle can be coupled with a charging system provided onshore/offshore by the charging trailer] and/or in a motion [e.g. provided in a dynamic charging system].

The charging stations, charging interfaces, first swappable rechargeable power sources, etc., can be provided at about the constructions which can be adjustable, mobile, controllable, etc., and which can provide charging, discharging, swapping for the electric vehicles when onboard (loaded) and/or when located at the charging trailers [e.g. the construction can be a mechanical construction (adjustably) coupling a vehicle with an electric vehicle; a robotic arm which can extend from the vehicle and pass a charging interface, a first swappable rechargeable power source, etc., to an electric vehicle located at the charging trailer on shore, etc.; a movable, extendable, folding, pivotably rotatable, etc., floor/e.g. a ramp/, a partition/e.g. a bulwark/, etc., which can include/be coupled with a wired/wireless charging station/charging interface can be unfolded to reach on the shore/e.g. a quay, a platform, etc./to charge/discharge the electric vehicle, etc.; the charging trailer can provide connectivity with a retractable charging cable of an electric bike, etc.].

The charging trailer charging system for an electric vehicle (VCS) can provide wired/wireless data transmissions being in relation with unidirectional/bidirectional power transfer while vehicles can be stationary and/or in motion. The data transmissions can be local [e.g. via charging interfaces of the vehicles, first/second swappable power sources, local wired/wireless networks or connections, etc.] and distant [e.g. via power cables coupling the vehicle (system) with power sources, communication cables, via satellite connections, telephone techniques, etc.]. The data transmissions can include underwater (acoustic) techniques, radio waves communications, (dubbed) optical communications [e.g. with infrared lasers], etc. The VCS can use any convenient type of communication interfaces, lines, techniques and protocols. The VCS can use telematic services.

VCS can be provided in various cloud/fog/edge architectures wherein communication/control systems can be at least partially in relation with charging/discharging the electric vehicles, the rechargeable power sources/swappable rechargeable power sources, the first/second swappable rechargeable power sources. The architectures can be provided e.g. within the Internet, the Internet of Things and the Industrial Internet of Things.

Cloud/fog/edge nodes can have local and global access. The system can enable processing, control and power management on local (edge, fog) level and information generation, servicing and control on global level (cloud). The system can enable power aggregation and interaction between power resources [e.g. power generators, onshore/offshore/aerospace power sources, etc.], rechargeable power sources/swappable rechargeable power sources, the first/second swappable rechargeable power sources and the charging stations provided by the vehicles. Cloud services can monitor data from fog nodes/edge nodes, human-machine interfaces [e.g. client smartphones], internet enabled devices, etc. The cloud services can make general decisions, store and process data and provide statistical analysis. The cloud/fog node/edge node system can set a real-time price for charging/discharging power based on received information from fog nodes/edge nodes [e.g. provided from different vehicles of a fleet], on power supply and demand from the electric vehicles, on power supply and demand from onshore/offshore/aerospace power sources, power generators, etc., according to power market evaluation, energy price trend and development.

The system can make offers for a future price [e.g. during a transportation, etc.] according to evaluation tests and model algorithms analysing data, implementing specific patterns to develop optimal charging/discharging/power transfer parameters [e.g. including the whole of the route estimating the time when the vehicle can be coupled with an static/dynamic power source, estimating power output from a solar collector provided by the vehicle and producing power usable by a charging station, etc.]. The system can provide renewable energy management, power to grid management, booking management, pricing management, etc. The system can provide a multilevel architecture [e.g. two-level wherein edge nodes can communicate directly with clouds; a three-level architecture including edge nodes, fog nodes and clouds, or combinations]. Each layer and the whole system can have various functionality patterns and architectures, can combine mobile and (geo-) stationary nodes.

The charging trailer can include and/or be coupled with power generators to produce power at least partially usable by said one or more charging stations, by the rechargeable power source, by the first/second swappable rechargeable power sources. The power generators can provide (autonomous) tempering systems, can feed the AC (smart) power grid, onboard ustensils, etc. The power generators can be coupled with (power) control systems of the vehicle and of the electric vehicle [e.g. controllers of the electric vehicles can convert DC power from a solar panel into (high voltage) batteries, invert DC power into AC power for an AC motor, or a grid, etc.].

Arrays of solar cells can be solar panels [e.g. monocrystalline, polycrystalline, thin-film/e.g. silicon nitride/, amorphous silicon, biohybrid, cadmium telluride, diamond, etc.], solar modules, solar towers, solar concentrators [e.g. inclusive of fresnel lens, parabolic mirrors and other optical power amplifying devices], etc. The solar panels can be flexible, foldable, extendable, incorporated into the “construction” of the vehicles, detachably attachable to the “construction” of the vehicles, mounted, laminated, coupled, etc., to a surface, provide azimuth/elevation solar tracking, etc.

Hydrogen power units including electrolysers and/or fuel cells can include hydrogen production units and hydrogen storage units. Hydrogen production units can be (terrestrial or aerospace) electrolysis systems [e.g. alkaline, solid oxide, microbial, proton exchange membrane (PEM), photo-electrochemical electrolysis systems, etc.], hydrocarbons reforming systems, alcohols reforming systems, sugars reforming systems, chemical processing systems, biological processing systems, biomass processing systems, thermal processing systems, photo processing systems, metal and water systems, etc. Hydrogen storage units can be compressed gas systems, liquified gas systems, chemical systems, electrochemical systems, physi-sorption systems, nanomaterial systems, intercallation in metals systems, intercallation in hydrides systems, inorganic gaseous sysems, inorganic liquids systems, inorganic solids systems, organic gaseous systems, organic liquids systems, organic solids systems, etc. Fuel cells can be (polymer electrolyte) proton exchange membrane (PEM), direct methanol, alkaline, phosphoric acid, molten carbonate, solid oxide, reversible, etc.

Wind energy to electric energy converters can be preferably but not exclusively wind turbines [e.g. horizontal axis, vertical axis, variable axis, etc.].

The charging trailer comprised in the VCS can be arranged to provide at least partially regenerative power during braking [e.g. via power switching devices] which can be used by the electric truck or locomotives, the charging stations, by the rechargeable power sources, by the first/second swappable rechargeable power sources. The charging trailer can provide any device to convert solar/wind motion energy into electric power. A motion energy can be converted while the charging trailer (and the electric truck or locomotive) is slowing down, going downhill, etc.

Electric energy and water can be used [e.g. in aerospace embodiments] to produce hydrogen and oxygen [e.g. by means of (unitized) regenerative (reverse) fuel cells, etc.].

The electric truck or locomotive can include and/or be coupled with the second swappable rechargeable power source which can be contained in a body/chassis or another construction and accessible from any part of e.g. the body/chassis construction [e.g. through a hood, trunk, doors, a fuselage opening, from underneath, from above, etc.] and can be swappable by any means [which can range from a manual system over a mechanical pulley, a cord, a rail, etc., system to a fully automatic, robotic, drone, etc., system] and from any side [from underneath, from above, from the front, from behind] and/or which can be contained in a coupled vehicle, mounted on a rack [e.g. a roof rack], coupled to the electric truck or locomotive from any side. The charging trailer can dispose charging/discharging/stocking capacity [e.g. dedicated chargers to charge/discharge the first/second swappable rechargeable power source, manipulating and computing systems] which can be provided onboard/onshore/in aerospace.

The rechargeable power sources can be dedicated rechargeable power sources to be used for the charging trailers, the first/second swappable rechargeable power sources charging/discharging purposes only or can be used for proper needs of the charging trailer [e.g. propelling systems, auxiliary systems, heating, ventilation and air conditioning (HVAC) systems, etc.], or can be used for other purposes, or combinations.

The rechargeable power sources, the first/second swappable rechargeable power sources can include a package [e.g. a container, a climatised container, a waterproof, watertight, buoyant container, a pressurised package, etc.], include and/or be coupled with a source management system which can include power electronics, communication interfaces, various circuit topologies including electrocomponents such as converters, inverters, voltage regulators, power factor corrections, rectifiers, filters, controllers, processors, etc. The source management systems can provide monitoring [e.g. State of Charge (SoC), etc.], calculating, reporting, cell balancing, controlling, etc., functions with regard to the energy management. The source management system can include energy management processors, databases, position identification system [e.g. global positioning satellite (GPS) system receivers, etc.] and provide intelligent source management using anticipated track and profile conditions, charging opportunities, past operating experience, etc.

The rechargeable power sources, the first/second swappable rechargeable power sources can include an energy storage element including a complex technology [e.g. including energy storage, energy transfer, energy harvesting, energy generating, etc.] which can include power electronics, communication interfaces, various circuit topologies, etc. The rechargeable power sources, the first/second swappable rechargeable power sources can be mobile units, compact units, enclosed units, portable units, skid mounted units, and the like.

The swappable rechargeable power sources, the first/second swappable rechargeable power sources can comprise a functional, communication, shape compatibility [e.g. can comprise compatible power transfer interfaces, compatible communication interfaces, compatible rechargeable power sources, compatible source management systems, power cables, thermal management systems, etc.]. The charging trailer can be arranged for easy, frequent and rapid swapping of the swappable rechargeable power source, the first/second swappable rechargeable power sources [e.g. the sources can be charged/discharged, prepared, stocked for a truck at a truck terminal, for a car at a service station, garage, for an electric bike at a street furniture, etc.].

The VCS can provide thermal management systems which can be included by the charging trailer and/or located on shore and coupled with the charging trailer to thermally manage charging and/or discharging the electric truck or locomotive, the rechargeable power sources, the first/second swappable rechargeable power sources. The thermally managed rechargeable power sources can be used for the electric truck or locomotive charging/discharging purposes only or can be used for proper needs of the charging trailer [e.g. propelling systems, auxiliary systems, etc.], or combinations.

The systems can thermally manage chargers of charging stations, charging cables, charging interfaces, rechargeable batteries and/or capacitors and/or energy storage elements of the power sources, etc. The thermal management systems of energy storage elements can include complex technologies. The systems can include ventilators, thermal exchangers, compressors, chillers, condensers, heaters, sensors, pumps, programmable controllers, thermal medium conducts, valves, heat pipes, vapor chambers, heat sinks, fillers, etc.

The systems can use thermal exchange with (offshore) water, air, ground, etc.

The charging stations, charging interfaces, first/second swappable rechargeable power sources can be provided in a close relationship [e.g. can be shape conform, aligned, recessed, protruding above a surface and can be attached, detachably attached, coupled, layered, mounted, posed, suspended, protected, transported, etc.] with a charging trailer's construction and can be provided in a loose relationship in a proximity-based environment or in a vicinity-based environment and can be provided distantly [e.g. in the coupled onboard-onshore systems, etc.].

Adjustability and mobility of charging stations/charging interfaces can provide charging and/or discharging the electric truck or locomotive, the rechargeable power sources, the first/second swappable rechargeable power sources in broadest sense [e.g. can assist in interfacing, coupling, arranging, cleaning, servicing, upgrading, etc.].

Both systems (adjustable and mobile) can use any convenient navigation, micronavigation, positioning, tracking systems and methods [e.g. vision, acoustic, electromagnetic, photoelectric, radio, telematic, etc.], can use sensors/multisensors [e.g. proximity, electrical, temperature sensors, relative/absolute attitude sensors, etc.], targets, cameras, controls, etc. Both systems can be powered mechanically, hydraulically, electrically, electromagnetically, pneumatically, manually, etc. Both systems can be controlled manually, computer, remote, radio, telematic, mobile, electrically, electronically, etc.

Both systems can be compact units wherein power electronics, communication units, etc., can be included in one unit with the charging interface or the chargers can be provided separately from the interfaces and can be coupled at least with power cables. Both systems (inclusive of the adjustability/mobility devices) can include or be coupled with any type of a sliding, rolling, floating, rotating, translational, suspended, etc., construction providing adjustability/mobility which can range from a retractable power cable or a rope to robotic arms, robots, drones, electromagnetic suspensions, etc., and which can include linear motors, rotary motors and various types of actuators. Both systems can provide various degrees of freedom. Both systems can use wired/wireless local/distant communication systems, networks, methods, and protocols.

Common requirements on the charging trailer charging system in cold areas The VCS can be provided in the Arctic, the Antarctic, subpolar, cold areas (e.g. aerospace, etc.]. In that case, components of the charging trailer and the system elements and components can be designed to be conform with cold, extremely cold, temporarily cold conditions. Charging interfaces can be specifically designed to be protected against cold and bad weather specially when exposed onboard. The rechargeable power sources, the first/second swappable rechargeable power sources [e.g. including rechargeable batteries] can be thermally insulated. Thermal management systems provided to manage charging and/or discharging can include heating systems.

No limitations are intended others than as described in the claims. The present invention is not limited to the described exemplary embodiments. It should be noted that various modifications and combinations of the elements of the VCS can be made without departing from the scope of the invention as defined by the claims.

The elements, components, integers, features, standards described in this description and the used terminology reflect the state of knowledge at the time of the filling of this application and may be developed in the future [e.g. charging standards, charging interfaces, chargers, rechargeable power sources, energy storage elements, communication techniques, fuels. hydrogen production and hydrogen storage techniques, electrolysis and fuel cell technologies, etc.].

### INDUSTRIAL APPLICABILITY

The present invention may provide wired/wireless charging system for electric trucks or locomotives by providing one or more wired/wireless charging stations, rechargeable power sources, thermal management system, mobile or adjustable charging interfaces, power and data transfer, power generators, etc.

The charging trailer can increase range of the electric trucks or locomotives.

The electric trucks or locomotives may use time when located at the charging trailer to charge/discharge.

The VCS may provide regenerative power and bidirectional power flow. The charging trailer and the electric truck or locomotive may provide each other with power according to (instantaneous/future) power demands. The power may be used to power drive systems, auxiliary systems, to recharge the rechargeable power source/swappable rechargeable power source of the vehicle, the first/second swappable rechargeable power sources.

The proposed swappability of the swappable rechargeable power sources may bring benefits provided by swapping rapidity, ease of servicing, etc.

The proposed date transmission which can be used e.g. in a cloud/fog/edge architecture may improve functionality of the system management, may enable the electric truck or locomotive to interact with the system [e.g. reserving charging capacity, optimalising the charging/discharging process, etc.], enable diverse modes of power trading.

The power generators using renewable sources (arrays of solar cells, wind energy to electric energy converters, wave energy to electric energy converters, tidal energy to electric energy converters, water currents energy to electric energy converters, thermal energy to electric energy converters, motor generators, aerospace power generators) may provide power to be used for zero emission power production and supply by the VCS.

The VCS may be provided in modular systems. The proposed modularity and scalability may concern all elements of the VCS and may bring functional and financial benefits to the parties. Modular designs may use various degrees of modularity [e.g. component slottability, platform systems, holistic approach, etc.]. Modules may be catalogued.

1. A charging trailer system for an electric truck or locomotive, said charging trailer (151) coupled or couplable with said electric truck or locomotive (154), said electric truck or locomotive (154) configured to be at least partially chargeable and/or dischargeable, the system characterized in that said charging trailer (151) comprises at least one charging station (152) with a wired charging interface (153) or with a wireless charging interface (243) or combinations thereof to charge/discharge said electric truck or locomotive (154).

2. (canceled)

3. The charging trailer system according to claim 1, further comprising an electric vehicle (224a, 224b) loaded on said charging trailer (221).

4. The charging trailer system according to claim 1, wherein said charging trailer (151) is coupled or couplable via one or more trailers and/or one or more said charging trailers (151) and/or one or more vehicles to said electric truck or locomotive (154).

5. The charging trailer system according to claim 1, further providing data transmissions being in relation with charging and/or discharging said electric truck or locomotive (144) and/or a rechargeable power source (145) provided by said charging trailer (141) and/or a first swappable rechargeable power source provided by said charging trailer (145a) and/or a second swappable rechargeable power (145b) source provided by said electric truck or locomotive (144).

6. The charging trailer system according to claim 1, wherein said charging trailer (131) is arranged to carry one or more persons and/or one or more objects (139).

7. The charging trailer system according to claim 1, wherein said charging trailer (141) and/or said electric truck or locomotive (144) provide a power generator (147) to generate power for at least one of said charging stations.

8. The charging trailer system according to claim 1, wherein said charging trailer (141) and/or said electric truck or locomotive (144) provide a rechargeable power source (145).

9. The charging trailer system according to claim 1, wherein said charging trailer (141) provides a thermal management system (148) to thermally manage charging and/or discharging said electric truck or locomotive (144) and/or a rechargeable power source (145) provided by said charging trailer (141) and/or a first swappable rechargeable power source (145a) provided by said charging trailer (141) and/or a second swappable rechargeable power source (145b) provided by said electric truck or locomotive (144), wherein at least one said thermal management system (148) is selected from the group consisting of fluid tempering systems, air tempering systems, liquid tempering systems, liquid tempering systems using offshore water as a thermal medium, tempering systems using phase change materials, tempering systems using heat pipes, cryogenic tempering systems, or combinations thereof.

10. The charging trailer system according to claim 1, wherein at least one said charging station (152) is selected from the group consisting of wired charging stations, wireless charging stations, AC charging stations, DC charging stations, inductive charging stations, capacitive charging stations, magnetodynamic charging stations, electromagnetic charging stations, or combinations thereof.

11. The charging trailer system according to claim 1, wherein at least one said charging station provides at least one charging interface (243), and wherein said charging station and/or said charging interface (243) are adjustable and/or mobile.

12. The charging trailer system according to claim 1, further comprising another electric vehicle coupled to at least one of said charging station types to be charged and/or discharged.

13. The charging trailer system according to claim 1, wherein said charging trailer system is provided as part of a static/dynamic charging system comprising: a power source (226), wherein said power source (226) is coupled to provide said one or more charging stations and/or a rechargeable power source provided by said charging trailer and/or a first swappable rechargeable power source provided by said charging trailer and/or a second swappable rechargeable power source provided by said electric truck or locomotive with charging and/or discharging power while said charging trailer (221) be stationary and/or in motion.

14. The charging trailer system according to claim 1, wherein said charging trailer (241) system is provided as part of a modular system (246).

15. A charging trailer charging method for an electric truck or locomotive, the method comprising steps of:
loading one or more said electric vehicles (114a, 114b) on a charging trailer (111) and/or locating one or more said electric vehicles (114a, 114b) at said charging trailer (111), said charging trailer (111) providing one or more charging stations (112a, 112b, 112c, 112d) and provided in a static/dynamic power transfer system comprising a power source coupled to provide said one or more charging stations (112a, 112b, 112c, 112d) with charging/discharging power;
at least partially charging and/or discharging said one or more electric vehicles (114a, 114b) by at least one of said one or more charging stations (112a, 112b, 112c, 112d) when onboard and/or when located at said charging trailer (111) while said charging trailer (111) be stationary and/or in motion,
said charging trailer (111) characterized in that it comprises at least one charging station with a wired charging interface or with a wireless charging interface or combinations thereof to charge/discharge said electric truck or locomotive.

16. A charging trailer charging method for an electric vessel, the method comprising steps of:
locating a charging trailer (231) providing charging power transfer on shore at said electric vessel (236) situated off shore and being chargeable by said charging trailer (231);
providing a charging power transfer between said charging trailer (231) and said electric vessel (236) while said electric vessel (236) be stationary and/or in motion,
said charging trailer (231) characterized in that it comprises at least one charging station with a wired charging interface or with a wireless charging interface or combinations thereof to charge/discharge an electric truck or locomotive (234).
